(19) United States
(12) Patent Application Publication
(10) Pub. No.: US 2011/0274811 A1
(43) Pub. Date: Nov. 10, 2011

(54) CELLULOSE GUMS WITH REDUCED VARIABILILTY AND METHOD FOR PRODUCING SAME

(76) Inventors: Mark Edward Hines, Moorestown, NJ (US); Dianne Patricia Leipold, Newark, DE (US)

(21) Appl. No.: 13/101,529

(22) Filed: May 5, 2011

Related U.S. Application Data
(60) Provisional application No. 61/331,930, filed on May 6, 2010.

(51) Int. Cl. C09D 101/26; C04B 7/02; A23L 1/0534; C09D 101/08

(52) U.S. Cl. 426/573; 106/163.01; 106/172.1; 106/204.01; 106/204.2; 106/204.3; 106/730

(57) ABSTRACT

A process for reducing the variability in commercial production lots of cellulose gums, such as cellulose ethers, in which inert substances, such as sucrose, salt, maltodextrin, or other relatively are blended with the cellulose gums to create products that exhibit less variability in certain a functional property, such as aqueous viscosity than commercial production lots which have not been subjected to the blending process.

### FIELD OF THE INVENTION

The present invention relates to a method for adjustment or calibration of functional characteristics of cellulose gums, to a desired targeted level.

### BACKGROUND OF THE INVENTION

Variations in raw materials and limitations in capabilities of production processes can result in variation of physical and chemical properties of hydrocolloids, including cellulose gums, during their manufacture. As a result, specifications of the hydrocolloids for functional properties, such as viscosity, are often more broad than desired by the industry to which the products are sold.

The variation in functional properties of hydrocolloids, such as viscosity, can cause problems in products in which they are used. Use of hydrocolloids exhibiting variations in their functional properties may result in a loss of production efficiency because of in-process adjustments that must be made to the products containing these hydrocolloids to compensate for such variations. As a result of variation of the functional properties of the hydrocolloids, the rate of unacceptable final products during a first production pass may be high, resulting in excessive rework and increased production expense. In some manufacturing processes, opportunities for in-process adjustment may be limited, and the resultant finished product quality may be dependent primarily on the quality of the raw materials used to produce the product. Use of hydrocolloids exhibiting variations in their functional properties may result in wide finished product variation, and possibly an increased rate of unacceptable product.

In certain hydrocolloids in order to reduce their variability, standardization of these hydrocolloids is accomplished through the incorporation of an amount of an acceptable inert substance, such as a sugar or salt. This is of particular importance in pectins where natural variability present pectins are mitigated through a standardization process. Pectins are typically standardized to a certain jelly grade by blending the pectin with an amount of a sugar, such as sucrose or dextrose, in order to arrive at a final pectin composition having a narrower range of gel strength. Another hydrocolloid, carrageenan has been standardized with a nutritive sweetening ingredient, or a salt, to provide a standardized carrageenan product. The amount of sugar that may be used to produce a standardized pectin is limited to an amount of not more than 44% by weight of the standardized pectin and the amount of nutritive sweetening ingredient in a standardized carrageenan product is limited to not more than 25% by weight of the standardized carrageenan.

However, cellulose gums, such as carboxymethylcellulose, while also exhibiting variability in their functional properties, have not been standardized. The use of such non-standardized cellulose gums may result in wide finished product variations and possibly an increased rate of unacceptable product. The need exists for a standardized cellulose gum which exhibits reduced variability in viscosity.

### BRIEF DESCRIPTION OF THE INVENTION

The present invention relates to a method for producing a standardized cellulose gum composition. The method comprises the steps of obtaining a representative sample of a cellulose gum to be standardized and dissolving the representative sample of cellulose gum to be standardized at various concentrations in a solvent to generate a functional property calibration curve. The cellulose gum to be standardized is blended with an amount of an adjusting agent, either a standardizing agent and/or a second cellulose gum the amounts determined through the use of the functional property calibration curve to generate a standardized cellulose gum composition.

Thus, one can achieve a functionally standardized cellulose gum by varying cellulose gum content with added standardizing agent or by varying the ratio of two cellulose gums. This latter method provides a standardized 100% cellulose gum which can be important in certain formulations and avoid the possibility of a change in ingredient statements.

The present invention will be further appreciated in light of the following detailed description and drawings in which:

### BRIEF DESCRIPTION OF THE FIGURE

FIG. 1 is a plot of viscosity versus the usage level of two high viscosity CMCs.

FIG. 2 is a plot of viscosity versus the usage level of MHEC with maltodextrin.

FIG. 3 is a plot of viscosity versus CMC usage level in a model beverage system.

### DETAILED DESCRIPTION OF THE INVENTION

The present process uses an adjusting agent, such as for example sucrose, to standardize cellulose gum and create production lots with reduced variation in a functional property such as viscosity. The amount of adjusting agent is formulated from a predictive calibration curve, based upon prior measurements of dosage and their resulting viscosity. This is achieved by intentionally varying the levels of the cellulose gum and adjusting agent, according to a pre-established formulation.

The term functional property defines a characteristic exhibited by the gum when dissolved in a solvent such as water or alcohol. These include viscosity, gel strength and protein stabilization, as well as any other measurable functional characteristic. These are relative terms.

Thus, with respect to viscosity, a high viscosity gum is one which when dissolved in, for example, water, increases the viscosity of the water more than desired. A low viscosity gum would increase the viscosity of the water less than desired.

The adjusting agent can be either a standardizing agent or a second cellulose gum with a higher or lower functionality than the first cellulose gum.

To achieve a cellulose gum with a desired level of functional property, a first cellulose gum is blended with a second cellulose gum and/or a standardizing agent in amounts defined by a formula predicted from a calibration curve. A calibration curve is established by blending different amounts of the first cellulose gum with varying amounts of one or more adjusting agents. The blends are dissolved in a solvent and the functional characteristic which is being standardized is measured. A graph of the blended components versus the functional characteristics provides the calibration curve. If two adjusting agents are used, one can be held constant while the other is variable.

In some blending situations, it may be desirable that the cellulose gum comprises a blend of two or more fractions of cellulose gum, with standardization agent to fully utilize product of differing quality characteristics. For example, a low viscosity cellulose gum may be blended with a portion of high viscosity cellulose gum, and then blended with sucrose to give a consistent viscosity value. When two cellulose gums are blended together, a standardization curve can be formed by blending different ratios of the two cellulose products optionally with a standardizing agent. Alternately, standardization can be accomplished with different concentrations of the cellulose gum and a standardizing agent such as sucrose.

The utility of this invention can be applied to commercial applications where the natural variability of cellulose gum used for viscosity creates unacceptable in-process or finished product viscosity variability. For example, a cellulose gum may be used in a coating, for developing a level of thickness or viscosity desirable for ideal application properties. However, production variability of the cellulose gum results in lot-to-lot variation that creates unacceptable variation for the coating, either in-process, for a finished product, or both. This invention provides a mechanism to substantially reduce the variation in the cellulose gum, resulting in greater efficiency and higher adherence to quality standards for the coating.

Of the cellulose gums useful in the present invention, cellulose ethers are preferred. The cellulose ether for use in the present invention may be any cellulose ether which is water soluble in nature and acceptable for a particular end use application. For example, certain carboxymethylcelluloses are approved for use in food applications. The cellulose ether of use in the present invention may be selected from the group consisting of hydroxyethylcellulose (HEC), hydroxypropyl cellulose (HPC), methylcellulose (MC), carboxymethylcellulose (CMC) and methylhydroxyethylcellulose (MHEC). The preferred cellulose ether is CMC.

The standardization agent of use in the present invention may be any material that is acceptable for a particular end use application and which is relatively inert in nature in that it does not contribute significantly to the functional property for which the cellulose gum is being used in the end use application. Also, the standardization agent should hydrate rapidly when added with the cellulose gum to an aqueous solvent, such as a sugar, salt or maltodextrin. For food applications, sugars, such as sucrose, dextrose or fructose. The preferred sugar is sucrose. Alternatively, the standardization agent could be a salt, such as NaCl or KCl. The standardization agent should also be easily dry blended with the cellulose gum to form the standardized cellulose gum composition.

In non-food applications, such as in paints or coatings, the standardization agent may be any filler or pigment conventionally used in water-based paints, for example chalk, dolomite, calcium carbonate, perlite, talc, kaolin, mica, gypsum, feldspar, calcite, titanium dioxide, zinc dioxide, etc. In a non-food application, such as papers, the standardization agent may be a mineral filler selected from the group consisting of calcium hydrate hemi hydrate, ground gypsum, Portland cement, calcium carbonate, clays, and powdered silica. Other inorganic species may also be of utility as the mineral filler.

The cellulose gum and the standardization agent may be blended using any of the various blending apparatuses used for blending dry powders such as double cone blenders, ribbon blenders and V-blenders. In certain cases, the blend is physically made in a blender made for combining dry powders into homogenous products. A V-blender or ribbon blender is well-suited for making these blends. Sucrose, with a smaller particle size distribution than what the industry calls “fine, granulated sugar” is best suited for mixing with CMC products, because the particle sizes are more compatible, and a more stable blended product is created. A product called by the sugar industry “baker's special sugar” is well-suited for blends with CMC products of regular granulation size.

The examples are presented to illustrate the invention, parts and percentages being by weight, unless otherwise indicated.

### EXAMPLES

### Example 1

A combination of a high viscosity CMC product (2800-6000 cps range at 1%), with a CMC product of a medium viscosity range (1500-3100 cps at 2%) are blended in ratios to create products with viscosity specifications more narrow than non-standardized CMC. These blends can then be further blended with sucrose to achieve viscosity in the range of medium viscosity CMC (such as 1500-3100 cps at 2%), but with more narrow viscosity specifications, such as 2100-2500, and with greater capability to create a product that will meet a specified viscosity target.

Aqueous solutions, with sodium benzoate (as a preservative), sodium hexametaphosphate (as a water conditioning agent), sorbic acid (as an acidulant and preservative), and salt were used to establish the viscosity levels of blends of high viscosity and medium viscosity CMC products. The CMC level remained constant at 1.3% (w/w, dry matter basis) in the solutions. The levels of the high viscosity CMC (2800-6000 cps at 1%) varied from 0.52% to 1.04% in the solution. Correspondingly, the medium viscosity CMC (1500-3100 cps at 2%) ranged from 0.78% to 0.26%. Sucrose was added, as a standardizing agent, at a constant 1.06%. The solutions were prepared by adding sorbic acid to warm water (50-55° C.), followed by dispersion of the CMC/sugar blends into the aqueous solution at 400 to 500 rpm, using an anchor stirrer and an overhead mixer. The fully hydrated solutions were measured for viscosity at 25° C., using a Brookfield LVT viscometer, at 30 rpm. Spindles 1-3 were used, depending upon the viscosity level.

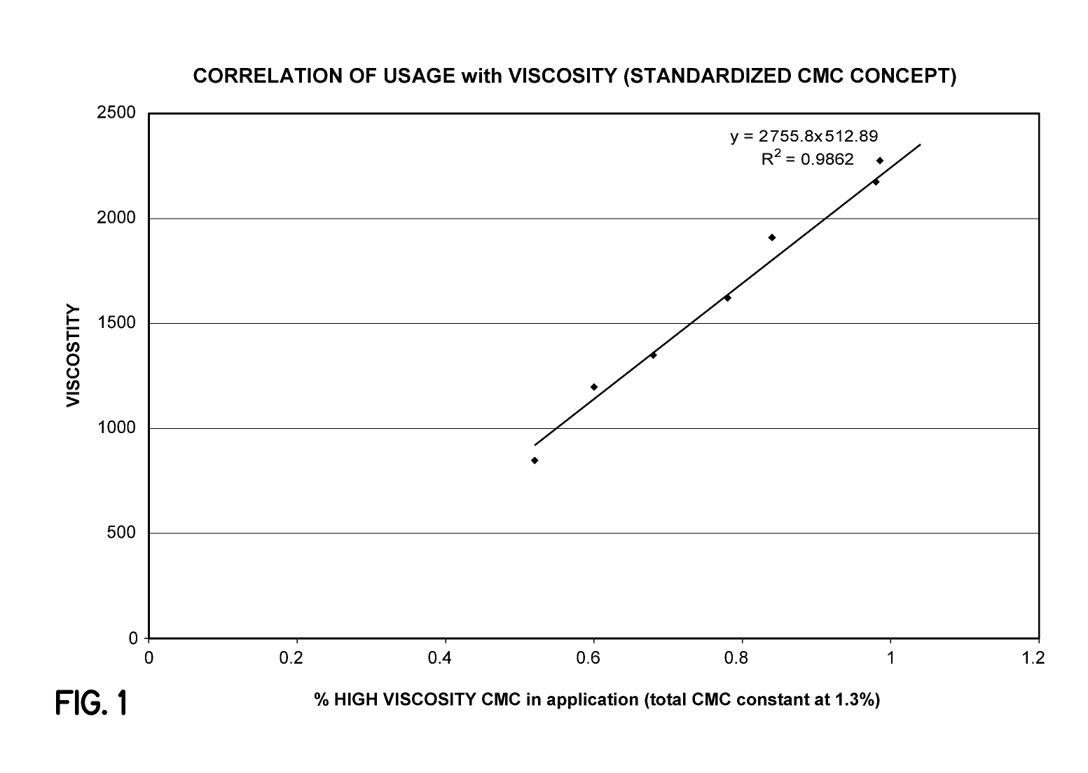

The viscosity results were then plotted against usage level, and a functional property calibration curve was developed (FIG. 1), based upon the best fit of the data. The curve of the best fit data was found to fit a linear equation; y=2755.8×−512.89, with a correlation coefficient, r², of 0.9862, for seven data points. This equation was then used to develop a blend of the two CMC products with a targeted viscosity level. A viscosity target of 2100 cps was selected. The line equation predicted 0.94% for the high viscosity CMC, with an accompanying level of 0.36% of the medium viscosity CMC, to produce a final level of 2100 cps. This translates to a blend of the high viscosity CMC at 40%, the medium viscosity CMC at 16%, and sucrose at 45%, used at a total level of 2.36%.

TABLE 1

| | Grams | Grams | Grams | Grams | Grams |
|---|---|---|---|---|---|
| WATER (125-130° F.) | 485.9 | 485.9 | 485.9 | 485.9 | 485.9 |
| (52-54° C.) | | | | | |
| PRESERVATIVES | 0.3 | 0.3 | 0.3 | 0.3 | 0.3 |
| CMC High Viscosity | 5.2 | 4.4 | 3.3 | 2 | 3.9 |
| CMC Medium Viscosity | 1.3 | 2.1 | 3.2 | 4.5 | 2.6 |
| SUGAR | 5.3 | 5.3 | 5.3 | 5.3 | 5.3 |
| SALT | 2 | 2 | 2 | 2 | 2 |
| TOTAL: | 500 | 500 | 500 | 500 | 500 |

Table 1 shows examples of formulations used to develop a functional property calibration curve for blending two types of CMC with sucrose for a product with viscosity at a medium viscosity CMC product, with reduced variation around the viscosity target. The sucrose content is held constant.

Using the prescribed levels of the two CMC products, a blend was made and then tested for the ability of the curve to predict viscosity. The resulting viscosity was found to be 2136 cps, within 2% of the predicted value.

FIG. 1 depicts the plots of viscosity vs usage level of two high viscosity CMC lots. These plots show strong correlation with exponential relationships, both lots showing an exponential function of about 4.3×. Similar relationships can be developed by using a power law relationship, which yields a power law function of about 1.69.

In generating the relationship depicted in FIG. 1, high viscosity CMC was used with medium viscosity CMC, in varying levels in relation to each other, but at constant total CMC levels, to create various levels of viscosity. A nearly linear relationship was produced with respect to viscosity.

### Example 2

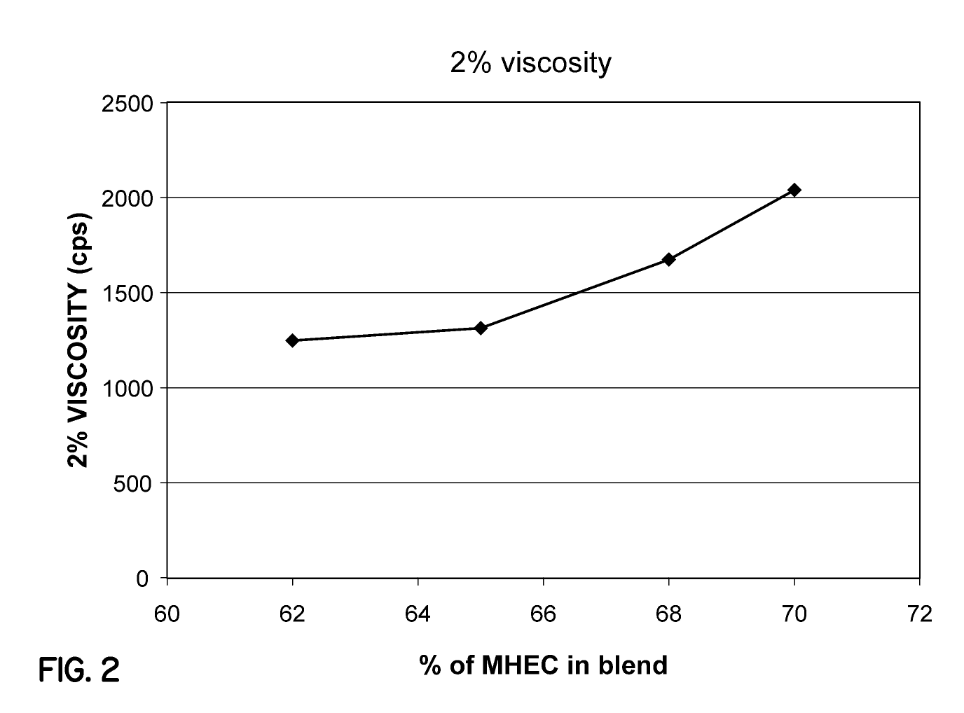

Methyl Hydroxyethylcellulose (MHEC) is a polymer used in pharmaceutical industries, among others, for purposes that include increasing viscosity in aqueous solutions. It is manufactured by derivatizing a backbone of cellulose polymer with methyl and hydroxyethyl groups to increase, among other properties, greater solubility in aqueous solutions. A series of blends of MHEC and maltodextrin (dextrose equivalence of 10) were made to reduce viscosity from a level of 3100-5700 or more, to 1200-1500 cps, when measured in a 2% solutions, by a Brookfield rotational viscometer, at 20° C., and using 20 rpm. These results are shown in FIG. 2 and in Table 2.

TABLE 2

| INGREDIENT | Reference | 1(%) | 2 (%) | 3 (%) | 4 (%) |
|---|---|---|---|---|---|
| MHEC | 100 | 70 | 68 | 65 | 62 |
| Maltodextrin | 0 | 30 | 32 | 35 | 38 |
| 2% viscosity¹, cps | 5134 | 2040 | 1674 | 1314 | 1248 |

¹Viscosity measured in 2% aqueous solution, at 20° C., using a Brookfield rotational viscometer, and measured at 20 rpm.

### Example 3

The standardization concept was also tested in a model beverage system (acidification and sweetener level common for juice type beverages). Medium viscosity CMC was used in varying levels from 95% to 65% blended with sucrose, and then added to the model beverage at constant levels. Viscosity was then measured for the resulting model beverages.

TABLE 3

| | 1 | 2 | 3 | 4 | 5 | 6 | 7 |
|---|---|---|---|---|---|---|---|
| PRODUCT | % | % | % | % | % | % | % |
| Medium viscosity | 95 | 90 | 85 | 80 | 75 | 70 | 65 |
| CMC | | | | | | | |
| SUGAR | 5 | 10 | 15 | 20 | 25 | 30 | 35 |
| TOTAL | 100 | 100 | 100 | 100 | 100 | 100 | 100 |

Procedure:
Mix CMC and sugar thoroughly.
Measure viscosity at 25° C., 30 rpm, with Brookfield rotational viscometer at 1.0% in triplicate.

Use the following model beverage system for measuring viscosity:

TABLE 4

| INGREDIENT | (g) | g/2000 g Batch |
|---|---|---|
| Sugar | 12 | 240 |
| 50% citric acid | to pH 3.8 | 1 drop |
| Blend from above | 1 | 20 |
| Water* | 88 | 1760 |
| TOTAL | 100 g | 2000 g |

*Minus quantity 50% citric acid solution added.

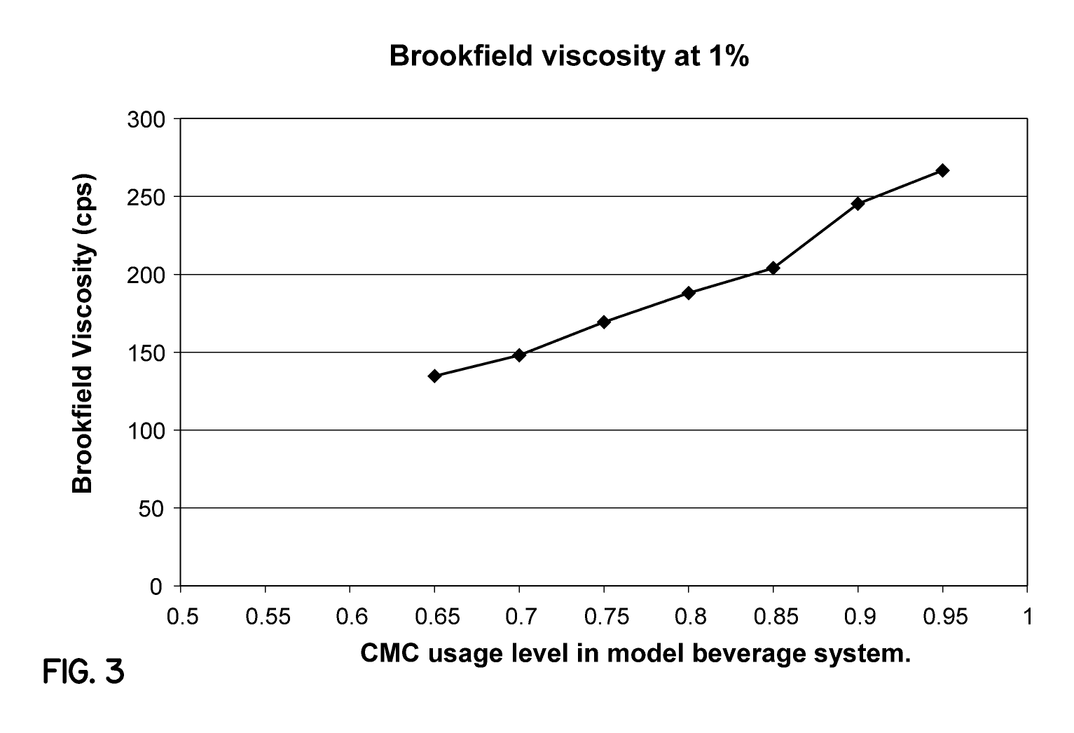

FIG. 3 shows the viscosity resulting from varying amount of CMC in model beverage system. Desired viscosity can be manipulated through a blend that varies the amount of CMC, relative to the intrinsic viscosity of a specific CMC manufacturing lot.

TABLE 5

| Trial | 1 | 2 | 3 | 4 | 5 | 6 | 7 |
|---|---|---|---|---|---|---|---|
| % CMC in preblend | 95 | 90 | 85 | 80 | 75 | 70 | 65 |
| % CMC in model beverage | 0.95 | 0.90 | 0.85 | 0.80 | 0.75 | 0.70 | 0.65 |
| 1% solution viscosity (cps) | 266.7 | 245.3 | 204 | 188 | 169.3 | 148 | 134.7 |

Viscosity measured by Brookfield rotational viscometer, at 25° C., 30 rpm

Table 5 shows the viscosity resulting from varying amount of CMC in model beverage system. Desired viscosity can be manipulated through a blend that varies the amount of CMC, relative to the intrinsic viscosity of a specific CMC manufacturing lot.

Although the invention has been illustrated by the above Examples, this is not to be construed as being limited thereby, but rather, the invention encompasses the generic area as hereinbefore disclosed. Various modifications and embodiments can be made without departing from the spirit and scope of the invention.

What is claimed:

1. A method of producing a standardized cellulose gum composition having a standardized functional property at a defined concentration comprising forming a plurality of blends of a first cellulose gum having a first functionality with an adjusting agent selected from the group of one or more second cellulose gums and one or more inert soluble diluents and blends thereof over a range of ratios;
measuring the functionality of said plurality of blends to establish a functionality curve;
forming a standardized blend of cellulose gum and said adjusting agent having a desired standard functionality by combining said first cellulose gum with said adjusting agent in relative amount conforming to said standardization curve.

2. The method claimed in claim 1 wherein said functionality is viscosity.

3. The method claimed in claim 2 wherein said first functionality is high viscosity and said adjusting agent is a cellulose gum having a lower viscosity than said first cellulose gum second functionality is low functionality relative to said high functionality.

4. The method claimed in claim 1 wherein said functionality is gel stabilization.

5. The method claimed in claim 1 wherein said functionality is protein stabilization.

6. The method of producing a standardized cellulose gum composition of claim 1 wherein the cellulose ether is selected from the group consisting of hydroxyethylcellulose (HEC), hydroxypropyl cellulose (HPC), methylcellulose (MC), carboxymethylcellulose (CMC) and methylhydroxyethylcellulose.

7. The method of producing a standardized cellulose gum composition of claim 6 wherein the cellulose ether comprises carboxymethylcellulose (CMC).

8. The method for producing a standardized cellulose gum composition of claim 1 wherein the cellulose gum to be standardized is dry blended with the adjusting agent.

9. The method for producing a standardized cellulose gum composition of claim 1 wherein the standardizing agent is a sugar.

10. The method for producing a standardized cellulose gum composition of claim 1 wherein the standardizing agent is a salt.

11. The method for producing a standardized cellulose gum composition of claim 10 wherein the standardizing agent is a sugar selected from the group consisting of sucrose, dextrose and fructose.

12. The method for producing a standardized cellulose gum composition of claim 10 wherein the standardizing agent is a salt selected from the group consisting of NaCl and KCl.

13. The method for producing a standardized cellulose gum composition of claim 1 wherein the standardizing agent is a filler or pigment conventionally used in water-based paints, for example chalk, dolomite, calcium carbonate, perlite, talc, kaolin, mica, gypsum, feldspar, calcite, titanium dioxide, zinc dioxide, etc.

14. The method for producing a standardized cellulose gum composition of claim 1 wherein the standardizing agent is a mineral filler selected from the group consisting of calcium hydrate hemi hydrate, ground gypsum, Portland cement, calcium carbonate, clays, and powdered silica.

15. A method for producing a standardized cellulose gum composition comprising the steps of:
a. dissolving a sample of cellulose gum to be standardized at various concentrations in a solvent to generate a functional property calibration curve; and
b. blending the cellulose gum to be standardized with an amount of a standardizing agent determined through the use of the functional property calibration curve to generate a standardized cellulose gum composition.

16. The method for producing a standardized cellulose gum composition of claim 15 wherein the cellulose gum is a cellulose ether.

17. The method for producing a standardized cellulose gum composition of claim 15 wherein the cellulose ether is selected from the group consisting of hydroxyethylcellulose (HEC), hydroxypropyl cellulose (HPC), methylcellulose (MC), carboxymethylcellulose (CMC) and methylhydroxyethylcellulose.

18. The method for producing a standardized cellulose gum composition of claim 17 wherein the cellulose ether comprises carboxymethylcellulose (CMC).

19. The method for producing a standardized cellulose gum composition of claim 15 wherein the cellulose gum to be standardized is dry blended with the standardizing agent.

20. The method for producing a standardized cellulose gum composition of claim 15, wherein the standardizing agent is a sugar.

21. The method for producing a standardized cellulose gum composition of claim 15 wherein the standardizing agent is a salt.

22. The method for producing a standardized cellulose gum composition of claim 20, wherein the standardizing agent is a sugar selected from the group consisting of sucrose, dextrose and fructose.
